(19) United States
(12) Patent Application Publication
(10) Pub. No.: US 2021/0380039 A1
(43) Pub. Date: Dec. 9, 2021

(54) Method and Apparatus for identifying objects

(71) Applicant: Aram Keledjian, Glendale, CA (US)

(72) Inventor: Aram Keledjian, Glendale, CA (US)

(21) Appl. No.: 17/234,654

(22) Filed: Apr. 19, 2021

Related U.S. Application Data
(60) Provisional application No. 62/978,478, filed on Feb. 19, 2020.

(51) Int. Cl. B60R 1/00; B60Q 9/00; B60R 11/04; H04N 5/247; G06K 9/00

(52) U.S. Cl. CPC B60R 1/00; B60Q 9/008; B60R 11/04; G06K 2209/23; G06K 9/00805; B60R 2300/802; B60R 2300/8066; H04N 5/247

(57) ABSTRACT

Disclosed is an optical sensor-based safety system for car that can detect difficult to see fast moving vehicle, such as scooters, bikes, etc. while changing a lane and alerts the driver about a potential accident with the fats moving vehicle.

### CROSS-REFERENCE TO RELATED APPLICATIONS

This application claims priority from the U.S. provisional patent application Ser. No. 62/978,478, filed on Feb. 19, 2020, which is incorporated herein by reference in its entirety.

### FIELD OF INVENTION

The present invention relates to a safety system, and more particularly, the present invention relates to a camera-based visual data technology with difficult to see fast moving object recognition in real time.

### BACKGROUND

Blind spot is one of the major reasons for accidents. While changing lanes the drive see the mirror for other vehicles in the lane. For example, the driver found out a car but form the mirror, no other vehicle can be seen in front or rear of that car and now the driver attempts to change the lane and get in front of the other car. However, there can be a third vehicle which was not visible and may result in the accident. Thus, a need is appreciated for a safety system.

### BRIEF DESCRIPTION OF DRAWINGS

FIG. 1 is a flow chart showing operating steps of the disclosed safety system, according to an exemplary embodiment of the present invention.

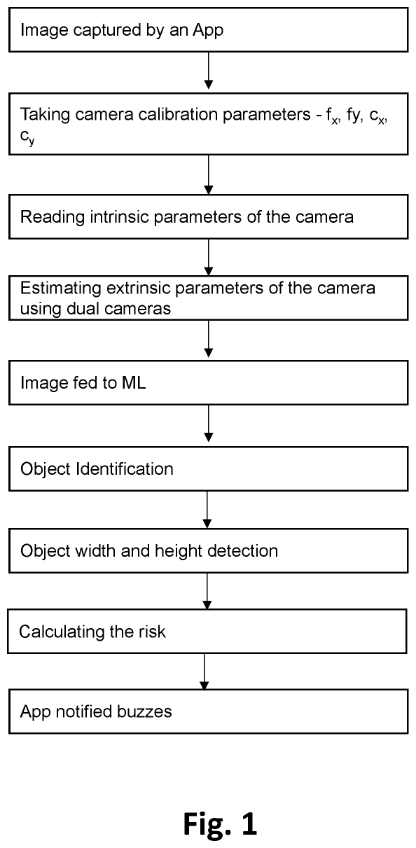

FIG. 2 is another flowchart showing operating steps of the disclosed safety system, according to an exemplary embodiment of the present invention.

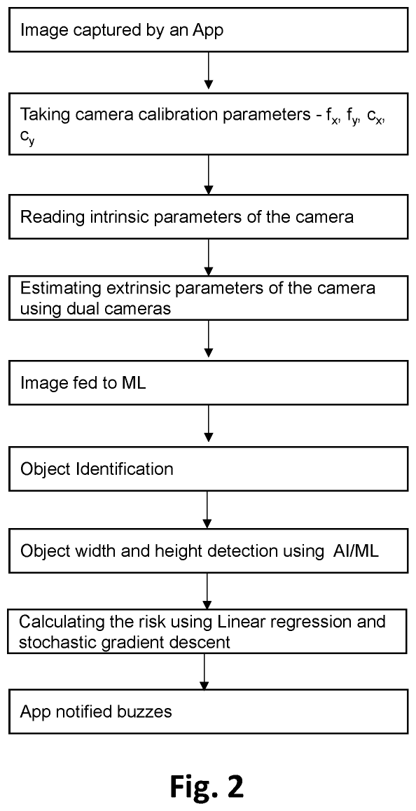

### DESCRIPTION

This technology will be available to markets including consumers, enterprise, medical, public transportation, and public safety. However, all of the disclosed products in every industry will have the ability to synchronize for public safety purposes in order to conduct mass data search such as license plates, facial recognition, type of vehicle and color. Secondary mass search function will constantly provide data such as exterior vehicles around the sensors, which are breaking the law, which can include texting or using their phone while driving or other unlawful activities. Upon installation, the customer will be notified about mass data search option; they can reject or accept it.

In real-time, the account admin can login and track what is happening with their drivers, should anything be out of the ordinary, and they can communicate directly through the sensor.

### Consumer & Enterprise Products

### Functions

Detection—Optical Sensor Intelligence will have multiple ranges, wide, mid, and long.
Blind Spot Assistance Motorcycles, Scooters, Bicycles, Pedestrians
Animals (deer, cow but not limited to) identified in rural areas, and if certain animals have a pattern of crossing same areas and which times. This information will be marked in the system, can provide to Deep map for people to be aware of possible risks.
Medical: Prior to a surgery-taking place, the operator will point a disclosed sensor/tablet on all of the tools to be used for surgery, and if everything checks out, they will proceed to the next phase asking to confirm a body part. Moreover, if the correct body part is scanned, then they will proceed with the surgery. If an incorrect tool is scanned, they will not be allowed to proceed.
Enterprise: A sensor at the back of a trailer can be set on to count what goes in/out of the trailer. If at some point the numbers don't add up, it can be tracked. This can be used in the warehouse to count inventory, and keep a steady count of daily sold and remaining inventory. Should something change, or an audit to take place, the inventory will have a very good track.
   Taxes—Can be integrated with accounting platforms for tax purposes
Medical: To identify a visual illness, the sensor can scan the patient to see if a similar illness exists.
Medical: Mole/Skin anomaly identification: Scan the mole or skin protrusion, the algorithm assesses if it matches something serious or not.
   Patient & Physician can download app—The app will scan all skin protrusions and track the evolution. Should anything grow too rapidly or display risk or potential, they system will notify the patient and physician. At any time, the physician and patient can go over the details on a regular basis, and track the precise growth.
Enterprise: Construction site—Forklifts, bulldozers, excavators, cranes and all of the other construction vehicles work among people. Disclosed sensors will help the vehicle operators know what is happening around them or if a person is too close to their work.
Home/Business Video surveillance—During theft or other crimes, Disclosed sensors will be able to detect and run facial recognition, tattoos in order to help police with the case.
Business Inventory Counter—Count inventory and identify what it is.
Distracted Driving
   How long the driver is distracted, how fast they were going and for how long
   Texting
   Using the Phone
   Tired
   Seat belt is on/off
   Smoking

### Driving Data

Complete list of driving data, such as speeds, hard breaks, aggressive accelerations. Complete summary of distractions, how long, at what speeds and how often this occurs. Summary of near accidents such as if the driver got too close and had near misses.

### Hardware

Disclosed optical sensory intelligence system with ability to cover 360 degrees around the vehicle. The sensor device positions will be in front of the vehicle, both sides, back and inside. Front Dashcam which has front and reverse cameras can focus on driver and the road. Multiple sensor options are available for one vehicle setup, depending on how much the driver wants to see. A single sensor set up is possible, however the customer has option of multiple sensors which can all sync together.

### Public Safety

### Everything Disclosed Sensors Pick Up Can be Used in a Court of Law

Functions—With the request of police all disclosed systems will be able to collect and share any visual data, images, license plates and any other appropriate visual data.

Detection—disclosed Optical Sensor Intelligence product will have multiple ranges, wide, mid and long.
Blind Spot Assistance—Motorcycles, Scooters, Bicycles, Pedestrians
Public area Police and squad cars sensors—Will let the local police department know should any foul play be taking place such as
   If any crime occurs
   If drugs are identified
   If a weapon of any kind is identified
   People meet in the same places and create a pattern
   Automatically scans all license plates
   Automatically scans for people of interest (facial recognition)
   Weapons of all types, guns, knives and others
   Aggressive/defensive approaching people toward the squad car or officer

The Time Travel Function for Court and Investigation use—Should a suspect or a criminal require an investigation, the police operator can upload their face, tattoo, license plate and any relative information and a timetable of visual data can trace everything that individual did on that day, prior and after, granted if they were picked up on disclosed sensor.
Drone System—When a squad car is working, the drones will be docked on top of the vehicle and will be scanning. Upon pulling over a vehicle, the officer will audibly activate the drone to follow the vehicle being pulled over. As the vehicle is in the final process of stopping, the drones will disengage and hover on each side of the vehicle, front, sides and back. Before the officer exits the squad vehicle, the drone(s) will observe and notify officer should the driver have a weapon, drugs, or is shuffling other objects in the vehicle. Should the person attempt to run away, the drones will follow the individual and provide critical data to the officer and HQ. The HQ can have the ability to take control of the drone or simply observe in real time.
Should the drone need to intervene with lethal or nonlethal means, it can.
Distracted Driving
   How long the driver is distracted, how fast they were going and for how long
   Texting
   Using the Phone
   Tired
   Smoking
   Seat belt on/off

### Driving Data

Complete list of driving data, such as speeds, hard breaks, aggressive accelerations. Complete summary of distractions, how long, at what speeds and how often this occurs. Summary of near accidents such as if the driver got too close and had near misses.

### Hardware

Disclosed OSi optical sensory intelligence system will have the ability to cover 360 degrees around the vehicle. The sensor device positions will be in front of the vehicle, both sides, back and interior. Front Dashcam which has front and reverse cameras can focus on driver and the road. Multiple sensor options are available for one vehicle setup, depending on how much the driver wants to see. A single sensor set up is possible, however the customer has option of multiple sensors which can all sync together.

### Drone

Can be equipped with non-lethal and lethal response, when drone disengage and follow the vehicle while being pulled over, the drone can be operated by local police officer from HQ and in case of an emergency can disengage a projectile lethal or non-lethal in case the on site officer is in trouble.
Multiple Drones can be set up per Squad car and will be able to sync with all of the disclosed sensors

Public Safety Gun Violence Instant Response—The drone will serve as a police officer on hibernation, it will be considered Police property

Should a shooting occur in a public building or school. Disclosed Drone will disengage from its docked area, this can be positioned above doorways where the exit signs are. It will immediately connect with local police department operator who will be able to see firsthand what's happening on the ground. Drone will follow the suspect and if absolutely needed, it can disengage a projectile which can be lethal or nonlethal, depending on what the situation is.

### Additional Functions

### Road Data

Disclosed sensors will always be reading what is happening around the vehicle, if someone else is texting and driving, or misusing the phone. However, data such as road construction or accidents will also be read. This information can be shared with deep map systems to provide a much better flow of data of what is truly happening on the streets in real time. This data can help anyone using navigation on their smartphones or other third party navigation systems and law enforcement. Should an accident occur, it will automatically notify the police.

### Defense

Border wall drone and optical sensors will cover walled and areas without walls. This is provide a wide-ranging data of how many people are coming in and out. Weather drugs or other anomalies are carried in. Which times of the day and which preferred areas are used. In addition, a sensor can be installed on the soldier's helmet, which will act as a 360 sensor to scan for potential dangers with night vision, infrared, and optical sensor.
The Scout—This function can zoom long distance to detect potential dangers. This process is achieved via multiple sensors including a sophisticated telephoto zoom sensor, people can be assessed, facial recognition, patterns, if someone is attempting surveillance, or doing anything with a pattern or unusual. Also used to defend areas such as the green zone, United States border, on military missions.
High Frame small fast moving object—Through a super-speed high frame rate sensor, fast-moving objects can be identified, this list includes but is not limited to bullets and its caliber, missile or any other diploid munition.
Frame Splitter. If the operator wants to see only certain type of objects on the screen they will have an option, such as if they want to only see people in the screen and exclude trees, vehicles and buildings.

### Big Data

Disclosed sensors will share real time vehicle data with autonomous vehicles, such as Tesla/Google. This source of information is critical because there is no other way non-autonomous vehicles can communicate with Tesla or Google vehicles in real time. Communications will provide distance, location, speeds, hard breaks, and any other pertinent information necessary for autonomous vehicles to achieve their full potential. Disclosed sensors will have various ways of exchanging data with other Disclosed sensors and third party customers such as Tesla/Google through Radio signals, Bluetooth, Wi-Fi and cellular phone hardware systems which will be activated via AT&T, T-Mobile or other cellular communication providers. Upon access approval from Tesla/Google to have access to their web services, disclosed system will then be able to share data via Tesla/Googles very own Web services used to communicate with their cars.

Parking Meter—Private Parking, Temporary Parking Assistant

As the meter patrol passes parked cars, disclosed sensor will recognize if the car has been in the same location from the very beginning. The position of the car, tires alignment will confirm that the car has not moved.

Third party Tow—Tow truck companies can have access to see which cars paid or which ones require impounding. Should a car come up in the automatic scan, the tow truck can impound that vehicle.

The receiver will be a small screen much like what you see in the image as well. And the second receiver will be the drivers cell phone.

The optical sensor can be easily installed like the dash cams to the back of the car window, and there will be additional sensors for the side of the car window and on rear view mirror. The receiver will be in the front, around dashboard area, a second receiver can be an app installed iOS or on Android cellphones. It will be integrated with these operating systems. The software will work all the while let say the driver has Google maps open and is watching the navigation guide them around town. Our system will overlap this screen with little icons of images (motorcycle helmet) or various colors chosen by the driver (circles, squares) which will identify that there is something different than just a car in their blind spot.

A little update on where we are and a use case: Currently we have validated our key functions, and are almost ready to pilot our flagship product to a handful of transportation companies. The difference between us and the usual sensors in cars is that our technology actually provides you additional data, such as objects other than just cars, i.e. motorcycles, scooters, bicycles. So, if you are driving, and your sensors goes off on the right-hand side, you check your mirror, you see a car has been detected, but there's nothing behind or in front of that car, and you want to get in front of that car. However, during the lane change process, a difficult to see object has not been detected, and in your lane transition period that object begins to zoom in-between you and the car to your right, the same one you are attempting to get in front of, this scenario and many like it are responsible for many accidents.

How our software works: It detects and identifies specified fast moving difficult to see objects in real time (motorcycles, scooters, bicycles). An optical sensor receives data, blue tooth or wired connection sends the information to the system, the system processes data and identifies the critical specified information then alert the drivers audibly and/or visually. The driver can change the option of how they are alerted, change sounds and images and colors.

We've identified several marketplaces which will benefit from this technology in addition to the intended marketplace such as Road Safety.

Our Initial product is meant to provide drivers with critical blind spot information such as Motorcycles, scooters and bicycles. These difficult vehicles come out of nowhere. Especially the scooters, they are smaller, faster and make zero noise, ranging in speed I 8-24 MPH.

Consumer market: The technology is a combination of easy to install sensors, such as Dashcam, attach our optical sensor to the back of the car window from inside. The receiver is in the front, where the dashboard is, and can be synced with the drivers cellphone or be a standalone device. When the key objects are in the drivers blind spot, the receiver will alert the driver audibly and/or visually, depending on their preferences.

Enterprise market, the product will be licensed on a yearly basis to customers such as insurance, transportation or ride share: We will develop a managing system i.e. SAS, Telematics, which will provide more in-depth information, in order to assess driving patterns. (We can make these available for the consumer market as well, to self-assess, and or for parents monitoring their children etc.)

Car Manufacturers: We can integrate our technology with their software and use their existing sensors, or add another optical sensor which will work solely with our technology.

### Additional Markets

Since the recent trade Show “Startup Grind” in Redwood city. We've been approached by several industries ranging in Medical, Animal Detection, Car Manufacturing and DARPA Medical area, our technology can help identify pre & during operation, example if any anomalies should exist, if anything is out of the place, such as Tools, paperwork, our technology will be a secondary checking system to mitigate error. Like a tablet or a wearable which will have a seamless check off process.

Animal detection: In rural areas, countries such as South Africa have approached us with collaborating in creating a solution to mitigate collisions with random Wild Animals and or cattle. In this case, we will also create a monitoring system, which will allow us to understand where are the usual areas of where the animals cross, times. And use this data to better understand and perhaps prevent these issues in the future.

Cellphone abuse prevention. We detect when the driver is abusing the cellphone while the car is In motion. The receiver at the dashboard is able to see the drivers eyeballs when they are on their cellphone. It registered this collection of data.

Also, the receiver will have a Bluetooth which can also connect with the cellphone in order to register its location in the car, and visually monitor the true driver.

Basically, any industry that requires detecting and identifying difficult to see objects will have a use case for our technology.

1. An optical sensory intelligence system for a vehicle comprises:
a plurality of optical sensors configured to be installed in a rear, sides, and front of the vehicle, one or more of the plurality of cameras configured to detect a fast-moving object in a blind spot of the vehicle; and
a receiver configured to receive and process data from the one or more of the plurality of cameras, the receiver further configured to generate an alert based on the critical specified information.

2. The optical sensory intelligence system according to claim 1, wherein a second receiver is configured in a smartphone, the second receiver configured to display the object as an icon overlay on a map in the smartphone.

3. The optical sensory intelligence system according to claim 1, wherein the fast-moving object is a scooter, motorcycle, bicycle, or a pedestrian.

4. The optical sensory intelligence system according to claim 1, wherein the plurality of optical sensors configured to cover 360 degrees around the vehicle.

5. A method of detecting and warning a driver of a vehicle about a difficult to see fast moving object, the method comprising the steps of:
providing a plurality of plurality of optical sensors configured to be installed in a rear, sides, and front of the vehicle, one or more of the plurality of cameras configured to detect a fast-moving object in a blind spot of the vehicle; and
receiving data from one or more of the plurality of cameras;
processing the data to determine a risk; and
generating an alert based on the risk.

6. The method according to claim 5, wherein the method further comprises the steps of:
receiving, information related to frequent animal crossing; and
proving on the map the information.
